(19) United States
(12) Patent Application Publication
(10) Pub. No.: US 2023/0213062 A1
(43) Pub. Date: Jul. 6, 2023

(54) PRESSURIZED FLUID SUPPLY SYSTEM

(71) Applicant: FANUC CORPORATION, Minamitsuru-gun (JP)

(72) Inventors: Makito NAKAMURA, Minamitsuru-gun, Yamanashi- ken (JP); Masahiro MUROTA, Minamitsuru-gun Yamanashi-ken (JP)

(21) Appl. No.: 18/018,240

(22) PCT Filed: Jul. 27, 2021
(86) PCT No.: PCT/JP2021/027620

§ 371 Date: Jan. 26, 2023

(30) Foreign Application Priority Data
Jul. 30, 2020 (JP) 2020-129025

(51) Int. Cl. F16C 32/06

(52) U.S. Cl. CPC F16C 32/06

(57) ABSTRACT

A pressurized fluid supply system capable of preventing damage to a member supported using a pressurized fluid even when the supply of the pressurized fluid from a fluid supply source is interrupted, includes: a fluid supply path for supplying the pressurized fluid from the fluid supply source to a support member that supports a member using the pressurized fluid; and a tank that is provided on the fluid supply path and stores the pressurized fluid.

### TECHNICAL FIELD

The present invention relates to a pressurized fluid supply system.

### BACKGROUND ART

JP 2018-109429 A discloses an aerostatic bearing device including: a rotating body including a spindle; and a bearing main body portion disposed radially outside the spindle so as to surround the spindle.

### SUMMARY OF THE INVENTION

However, in the aerostatic bearing device described in JP 2018-109429 A, there is a possibility that the spindle may be damaged if supply of pressurized fluid from a fluid supply source is disrupted in a state where the spindle is rotating.

An object of the present invention is to provide a pressurized fluid supply system capable of preventing a member supported by using a pressurized fluid from being damaged even when supply of pressurized fluid from a fluid supply source is disrupted.

According to an aspect of the present invention, there is a pressurized fluid supply system including: a fluid supply path configured to allow a pressurized fluid from a fluid supply source to be supplied to a support unit configured to support a member using the pressurized fluid; and a tank provided on the fluid supply path and configured to store the pressurized fluid.

According to the present invention, it is possible to provide a pressurized fluid supply system capable of preventing a member supported by using a pressurized fluid from being damaged even when supply of the pressurized fluid from a fluid supply source is disrupted.

### BRIEF DESCRIPTION OF DRAWINGS

FIG. 1A is a block diagram illustrating a pressurized fluid supply system according to a first embodiment;

FIG. 1B is a block diagram illustrating the pressurized fluid supply system according to the first embodiment;

FIG. 2 is a graph showing an evaluation result;

FIG. 3A is a block diagram illustrating a pressurized fluid supply system according to a second embodiment;

FIG. 3B is a block diagram illustrating the pressurized fluid supply system according to the second embodiment;

FIG. 4 is a graph showing an evaluation result;

FIG. 5A is a block diagram illustrating a pressurized fluid supply system according to a third embodiment; and

FIG. 5B is a block diagram illustrating the pressurized fluid supply system according to the third embodiment.

### DETAILED DESCRIPTION OF THE INVENTION

A pressurized fluid supply system according to the present invention will be described in detail below by way of preferred embodiments and with reference to the accompanying drawings.

### First Embodiment

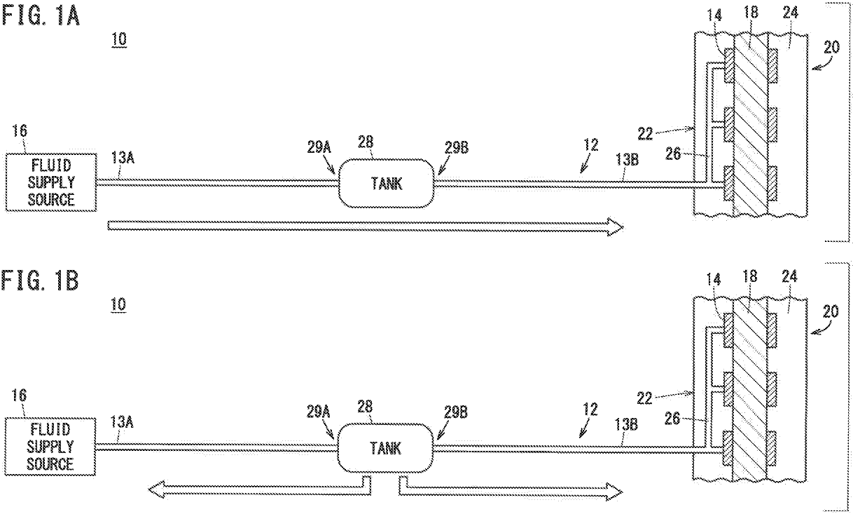

A pressurized fluid supplying system according to a first embodiment will be described with reference to FIG. 1A and FIG. 1B. FIGS. 1A and 1B are block diagrams illustrating the pressurized fluid supply system according to the present embodiment. FIG. 1A shows a state where a pressurized fluid is normally supplied from a fluid supply source 16 to a fluid supply path 12. FIG. 1B shows a state where the supply of the pressurized fluid from the fluid supply source 16 to the fluid supply path 12 is disrupted. Arrows in FIGS. 1A and 1B schematically show the flow of the pressurized fluid.

As shown in FIG. 1A, the pressurized fluid supply system 10 according to the present embodiment is provided with the fluid supply path 12. The fluid supply path 12 allows a pressurized fluid from the fluid supply source 16 to be supplied to a support unit (a support member) 14 described below. Here, a case where the pressurized fluid is a pressurized gas will be described as an example, but the present invention is not limited thereto. The pressurized fluid may be a pressurized liquid. The liquid may include, but is not limited to, water, oil and the like. The support unit 14 may support the member 18 described below, using a pressurized fluid. The length of the fluid supply path 12 is, for example, about 2 to 3 meters, but is not limited thereto. The inner diameter of the fluid supply path 12 is, for example, about 4.5 mm, but is not limited thereto. The fluid supply path 12 can be configured by, for example, pipes 13A, 13B, but is not limited thereto. Reference numeral 13 is used to express the pipes collectively, and reference numerals 13A and 13B are used to describe the individual pipes.

The fluid supply source 16 includes, for example, a compressor (not illustrated), a regulator (not illustrated), and the like. The fluid supply source 16 may supply pressurized fluid to the support unit 14 via the fluid supply path 12.

The support unit 14 may support a member 18 using the pressurized fluid supplied from the fluid supply source 16. More specifically, the support unit 14 may rotatably or slidably support the member 18 using the pressurized fluid supplied from the fluid supply source 16. The support unit 14 is, for example, a static pressure bearing, but is not limited thereto. The member 18 is, for example, a shaft, but is not limited thereto. Here, a case where the support unit 14 and the member 18 are provided on a spindle 22 of a machine tool 20 will be described as an example, but the present invention is not limited thereto.

The spindle 22 is provided with a housing 24. A gas supply passage 26 communicating with the fluid supply path 12 is formed in the housing 24. Pressurized fluid may be supplied to the support unit 14 via the gas supply passage 26. That is, the pressurized fluid can be supplied to the static pressure bearing via the gas supply passage 26. Although the spindle 22 is provided with components other than these components, the description thereof is omitted here.

A tank 28 for storing the pressurized fluid is provided on the fluid supply path 12. The capacity of the tank 28 is set to be sufficiently larger than the inner volume of the pipe 13 constituting the fluid supply path 12. The capacity of the tank 28 is, for example, about 5 liters, but is not limited thereto. The tank 28 includes, for example, an opening 29A and an opening 29B. In the example shown in FIG. 1A, one end of the pipe 13A is connected to the opening 29A of the tank 28, and the other end of the pipe 13A is connected to the fluid supply source 16. In the example shown in FIG. 1A, one end of the pipe 13B is connected to the opening 29B of the tank 28, and the other end of the pipe 13B is connected to the gas supply passage 26 of the spindle 22. Reference numeral 29 is used to express the openings collectively, and reference numerals 29A and 29B are used to describe the individual openings.

When the pressurized fluid from the fluid supply source 16 is normally supplied to the fluid supply path 12, the pressurized fluid flows through the fluid supply path 12 as shown in FIG. 1A. That is, the pressurized fluid supplied from the fluid supply source 16 flows into the tank 28 via the pipe 13A. The pressurized fluid flowing into the tank 28 through the pipe 13A is supplied to the support unit 14 through the pipe 13B.

When the supply of the pressurized fluid from the fluid supply source 16 to the fluid supply path 12 is disrupted, as shown in FIG. 1B, the pressurized fluid stored in the tank 28 is supplied to the support unit 14 via the pipe 13B. Since the capacity of the tank 28 is sufficiently large, the pressurized fluid stored in the tank 28 continues to be supplied to the support unit 14 for a relatively long time. Therefore, according to the present embodiment, a sudden pressure drop of the pressurized fluid supplied to the support unit 14 is suppressed.

As shown in FIG. 1B, part of the pressurized fluid stored in the tank 28 may also flow toward the fluid supply source 16 via the pipe 13A.

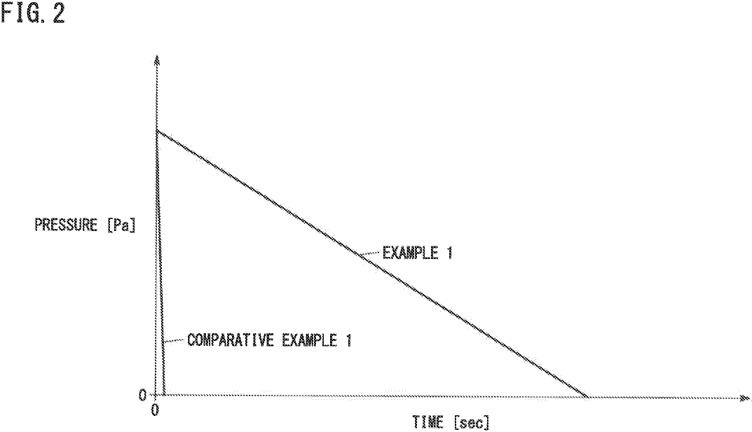

FIG. 2 is a graph showing an evaluation result. The horizontal axis of FIG. 2 indicates the time that elapses after the supply of the pressurized fluid from the fluid supply source 16 to the fluid supply path 12 has been disrupted. The vertical axis of FIG. 2 represents the pressure of the pressurized fluid supplied to the support unit 14. Example 1 in FIG. 2 shows a case of the present embodiment, that is, a case where the tank 28 is provided on the fluid supply path 12. Comparative Example 1 in FIG. 2 shows a case where the tank 28 is not provided on the fluid supply path 12.

As can be seen from FIG. 2, in the case of Comparative Example 1, when the supply of the pressurized fluid from the fluid supply source 16 to the fluid supply path 12 is disrupted, the pressure of the pressurized fluid supplied to the support unit 14 decreases in a relatively short time. On the other hand, in Example 1, that is, in the case of the present embodiment, after the supply of the pressurized fluid from the fluid supply source 16 to the fluid supply path 12 has been disrupted, the pressure of the pressurized fluid supplied to the support unit 14 maintains a relatively high pressure for a relatively long time.

As described above, according to the present embodiment, since the tank 28 is provided on the fluid supply path 12, even if the supply of the pressurized fluid from the fluid supply source 16 to the fluid supply path 12 is disrupted, the pressurized fluid stored in the tank 28 continues to be supplied to the support unit 14 for a relatively long time. For this reason, according to the present embodiment, it is possible to sufficiently lengthen the length of time that elapses before the pressurized fluid excessively decreases in pressure. Since the length of time that elapses before the pressurized fluid excessively decreases in pressure can be made sufficiently long, according to the present embodiment, it is possible to stop rotating movement, sliding movement, or the like of the member 18 before the pressurized fluid excessively decreases in pressure. Therefore, according to the present embodiment, even if the supply of the pressurized fluid from the fluid supply source 16 to the fluid supply path 12 is disrupted, it is possible to prevent the member 18 supported by using the pressurized fluid from being damaged.

### Second Embodiment

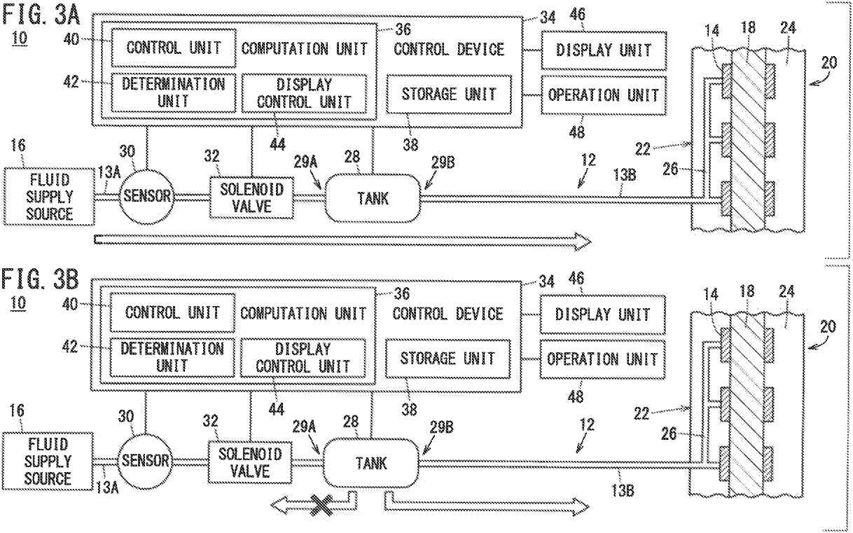

A pressurized fluid supply system according to a second embodiment will be described with reference to FIGS. 3A and 3B. The same components as those of the pressurized fluid supply system according to the first embodiment shown in FIGS. 1A to 2 are denoted by the same reference numerals, and description thereof will be omitted or simplified. FIGS. 3A and 3B are block diagrams illustrating the pressurized fluid supply system according to the present embodiment. FIG. 3A shows a state where the pressurized fluid is normally supplied from the fluid supply source 16 to the fluid supply path 12. FIG. 3B shows a state in which the supply of the pressurized fluid from the fluid supply source 16 to the fluid supply path 12 is disrupted. Arrows in FIGS. 3A and 3B schematically show the flow of the pressurized fluid.

In the pressurized fluid supply system 10 according to the present embodiment, a solenoid valve 32 is provided on the fluid supply path 12 between the fluid supply source 16 and the tank 28.

As shown in FIG. 3A, the solenoid valve 32 is provided on the fluid supply path 12 between the fluid supply source 16 and the tank 28. The solenoid valve 32 is, for example, a normally-closed solenoid valve, but is not limited thereto.

A sensor 30 is provided on the fluid supply path 12. The sensor 30 is, for example, a pressure sensor, but is not limited thereto. When sensor 30 is a pressure sensor, the sensor 30 may detect the pressure of the pressurized fluid supplied from the fluid supply source 16. In the example shown in FIG. 3A, the sensor 30 is provided on the fluid supply path 12 between the fluid supply source 16 and the solenoid valve 32, but the present invention is not limited thereto. The sensor 30 may be provided on the fluid supply path 12 between the solenoid valve 32 and the support unit 14. Even when the sensor 30 is provided on the fluid supply path 12 between the solenoid valve 32 and the support unit 14, the pressure of the pressurized fluid supplied from the fluid supply source 16 can be detected with the sensor 30.

The pressurized fluid supply system 10 is further provided with a control device 34. The control device 34 is equipped with a computation unit 36 and a storage unit 38. The computation unit 36 may be configured by a processor such as a CPU (Central Processing Unit) or the like, however the present invention is not limited to this feature. The computation unit 36 includes a control unit 40, a determination unit 42, and a display control unit 44. The control unit 40, the determination unit 42, and the display control unit 44 can be realized by the computation unit 36 executing a program stored in the storage unit 38.

The storage unit 38 is equipped with a volatile memory and a nonvolatile memory, neither of which are shown. As examples of the volatile memory, there may be cited a RAM (Random Access Memory) or the like. As examples of the nonvolatile memory, there may be cited a ROM (Read Only Memory), a flash memory, or the like. Programs, data, and the like may be stored in the storage unit 38. Data indicating a normal range of the pressure, etc. detected by the sensor 30 may be stored in advance in the storage unit 38.

The control unit 40 performs overall control of the control device 34. The control unit 40 can control opening and closing of the solenoid valve 32.

The determination unit 42 may determine whether or not the pressure detected by the sensor 30 is within the normal range. When the determination unit 42 determines that the pressure detected by the sensor 30 is outside the normal range (outside a normal pressure range), the control unit 40 may perform control to close the solenoid valve 32.

As described above, in the example shown in FIG. 3A, the sensor 30 is positioned between the fluid supply source 16 and the solenoid valve 32. The reason why the sensor 30 is positioned between the fluid supply source 16 and the solenoid valve 32 in the example shown in FIG. 3A is as follows. That is, when the pressure detected by the sensor 30 is outside the normal pressure range, the solenoid valve 32 is closed by the control unit 40. When the sensor 30 is positioned between the solenoid valve 32 and the support unit 14, the supply of the pressurized fluid to the sensor 30 is blocked by the closed solenoid valve 32, so that the sensor 30 cannot detect whether or not the pressure of the pressurized fluid supplied from the fluid supply source 16 has returned to a normal level. On the other hand, when the sensor 30 is positioned between the fluid supply source 16 and the solenoid valve 32, even if the solenoid valve 32 is closed, the sensor 30 can detect whether or not the pressure of the pressurized fluid supplied from the fluid supply source 16 returns to a normal level. For this reason, in the example shown in FIG. 3A, the sensor 30 is located between the fluid supply source 16 and the solenoid valve 32. However, as described above, the sensor 30 may be provided on the fluid supply path 12 between the solenoid valve 32 and the support unit 14. In this case, by opening the closed solenoid valve 32, it is possible to detect, with the sensor 30, whether or not the pressure of the pressurized fluid supplied from the fluid supply source 16 has returned to the normal level.

A display unit 46 may be connected to the control device 34. The display control unit 44 can display the pressure, etc. detected by the sensor 30 on the display screen of the display unit 46. The display control unit 44 can display whether or not the pressure detected by the sensor 30 is within the normal pressure range, on the display screen of the display unit 46. The display unit 46 can be constituted, for example, by a liquid crystal display or the like, however the present invention is not limited to this feature.

An operation unit 48 may be connected to the control device 34. The operation unit 48 can be constituted, for example, by a keyboard, a mouse, or the like, however the present invention is not limited to this feature. The operation unit 48 may be constituted by a non-illustrated touch panel provided on the screen of the display unit 46. The user can perform an operation input to the control device 34 via the operation unit 48.

When the pressurized fluid from the fluid supply source 16 is normally supplied to the fluid supply path 12, the pressurized fluid flows through the fluid supply path 12 as shown in FIG. 3A.

When the supply of the pressurized fluid from the fluid supply source 16 to the fluid supply path 12 is disrupted, the pressure detected by the sensor 30 is out of the normal pressure range, and the solenoid valve 32 is closed by the control unit 40. When the solenoid valve 32 is closed, as shown in FIG. 3B, the pressurized fluid stored in the tank 28 does not flow toward the fluid supply source 16. Therefore, according to the present embodiment, when the supply of the pressurized fluid from the fluid supply source 16 to the fluid supply path 12 is disrupted, the pressurized fluid stored in the tank 28 can be sufficiently supplied to the support unit 14 via the pipe 13B.

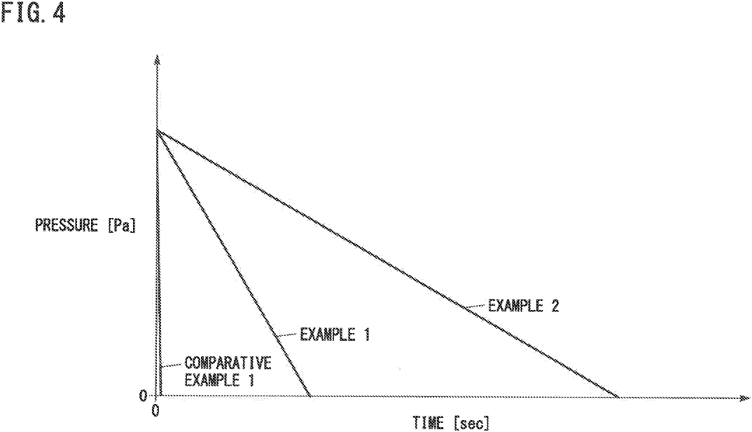

FIG. 4 is a graph showing an evaluation result. The horizontal axis of FIG. 4 indicates the time that elapses after the supply of the pressurized fluid from the fluid supply source 16 to the fluid supply path 12 has been disrupted. The vertical axis of FIG. 4 represents the pressure of the pressurized fluid supplied to the support unit 14. Example 2 in FIG. 4 shows a case of the present embodiment, that is, the case where the solenoid valve 32 is provided between the fluid supply source 16 and the tank 28. Example 1 and Comparative Example 1 in FIG. 4 are the same as Example 1 and Comparative Example 1 described above with reference to FIG. 2.

As can be seen from FIG. 4, in Example 2, that is, in the case of the present embodiment, after the supply of the pressurized fluid from the fluid supply source 16 to the fluid supply path 12 is disrupted, the pressure of the pressurized fluid supplied to the support unit 14 maintains a sufficiently high pressure for an extremely long time.

Although the case where the sensor 30 is a pressure sensor has been described as an example, the sensor 30 is not limited thereto. The sensor 30 may be a flow sensor that detects the flow rate of the pressurized fluid. When the flow rate detected by the sensor 30 is out of a normal flow rate range, the control unit 40 may perform control to close the solenoid valve 32. When the sensor 30 is a flow sensor, the sensor 30 can detect whether or not the flow rate of the pressurized fluid supplied from the fluid supply source 16 has returned to a normal level by opening the closed solenoid valve 32.

As described above, according to the present embodiment, the solenoid valve 32 is provided on the fluid supply path 12 between the fluid supply source 16 and the tank 28, and the solenoid valve 32 is closed when the supply of the pressurized fluid from the fluid supply source 16 to the fluid supply path 12 is disrupted. Therefore, according to the present embodiment, when the supply of the pressurized fluid from the fluid supply source 16 is disrupted, the pressurized fluid stored in the tank 28 can be sufficiently supplied to the support unit 14 via the pipe 13B. For this reason, according to the present embodiment, it is possible to more reliably prevent a sudden pressure drop of the pressurized fluid used to support the member 18, and it is possible to more sufficiently lengthen the length of time that elapses before the pressurized fluid excessively decreases in pressure. Since the length of time before the pressurized fluid excessively decreases in pressure can be more sufficiently lengthened, according to the present embodiment, the rotating movement, sliding movement, or the like of the member 18 can be more reliably stopped before the pressurized fluid excessively decreases in pressure. Therefore, according to the present embodiment, even if the supply of the pressurized fluid from the fluid supply source 16 to the fluid supply path 12 is disrupted, it is possible to more reliably prevent damage to the member 18 supported by using the pressurized fluid.

### Third Embodiment

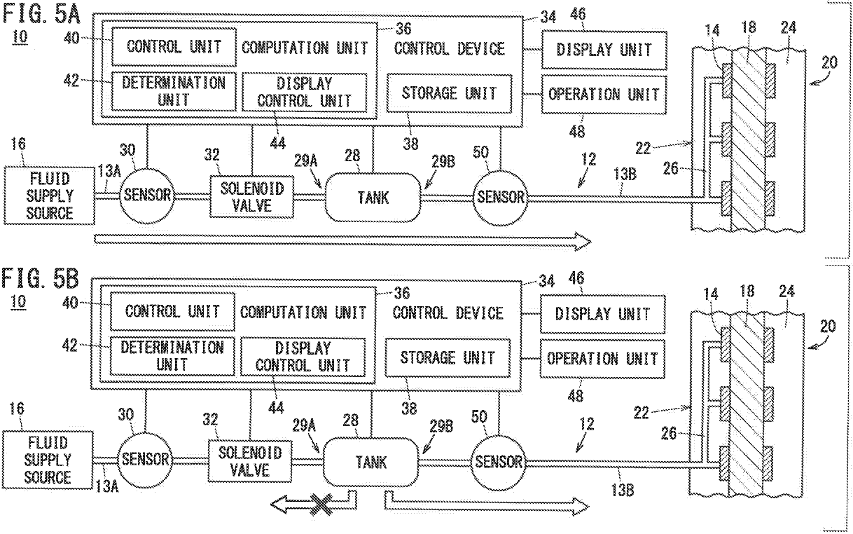

A pressurized fluid supply system according to a third embodiment will be described with reference to FIGS. 5A and 5B. The same components as those of the pressurized fluid supply system according to the first or second embodiment shown in FIGS. 1A to 4 are denoted by the same reference numerals, and description thereof will be omitted or simplified. FIGS. 5A and 5B are block diagrams illustrating the pressurized fluid supply system according to the present embodiment. FIG. 5A shows a state where the pressurized fluid is normally supplied from the fluid supply source 16 to the fluid supply path 12. FIG. 5B shows a state in which the supply of the pressurized fluid from the fluid supply source 16 to the fluid supply path 12 is disrupted. Arrows in FIGS. 5A and 5B schematically show the flow of the pressurized fluid.

In the pressurized fluid supply system 10 according to the present embodiment, two sensors, i.e., a sensor 30 and a sensor 50, are provided on the fluid supply path 12. The sensor 30 is, for example, a pressure sensor, and the sensor 50 is, for example, a flow sensor. The flow sensor may detect the flow rate of the pressurized fluid.

As shown in FIG. 5A, a sensor 50 (flow sensor) is provided on the fluid supply path 12. In the example shown in FIG. 5A, the sensor 50 (flow sensor) is provided on the fluid supply path 12 between the solenoid valve 32 and the support unit 14, but the present invention is not limited thereto. The sensor 50 (flow sensor) may be provided on the fluid supply path 12 between the fluid supply source 16 and the solenoid valve 32. Even when the sensor 50 is provided on the fluid supply path 12 between the fluid supply source 16 and the solenoid valve 32, the flow rate of the pressurized fluid can be detected with the sensor 50. In addition, although the sensor 30 is provided on the fluid supply path 12 between the fluid supply source 16 and the solenoid valve 32 in the example shown in FIG. 5A, the present invention is not limited thereto. The sensor 30 (pressure sensor) may be provided on the fluid supply path 12 between the solenoid valve 32 and the support unit 14. Even when the sensor 30 is provided on the fluid supply path 12 between the solenoid valve 32 and the support unit 14, the pressure of the pressurized fluid supplied from the fluid supply source 16 can be detected with the sensor 30.

The determination unit 42 can determine whether or not the pressure detected by the sensor 30 (pressure sensor) is within the normal pressure range. The determination unit 42 can determine whether or not the flow rate detected by the sensor 50 (flow sensor) is within the normal flow rate range.

When the pressure detected by the sensor 30 is within the normal pressure range and the flow rate detected by the sensor 50 is within the normal flow rate range, the determination unit 42 can determine that the pressurized fluid supply system 10 is normal. In such a case, the display control unit 44 displays no message on the display screen of the display unit 46.

There may be a case where the pressure detected by the sensor 30 is within the normal pressure range while the flow rate detected by the sensor 50 is outside the normal flow rate range. The cause of occurrence of the above case where the pressure detected by the sensor 30 is within the normal pressure range while the flow rate detected by the sensor 50 is outside the normal flow rate range may be, for example, that the support unit 14 (static pressure bearing) is subjected to clogging. Therefore, when the pressure detected by the sensor 30 is within the normal pressure range while the flow rate detected by the sensor 50 is outside the normal flow rate range, the determination unit 42 can determine that an abnormality has occurred in the support unit 14. In such a case, the display control unit 44 displays a message indicating that an abnormality has occurred in the support unit 14, on the display screen of the display unit 46.

There may be a case where the pressure detected by the sensor 30 is outside of the normal pressure range while the flow rate detected by the sensor 50 is within the normal flow rate range. The cause of occurrence of the above case where the pressure detected by the sensor 30 is outside the normal pressure range while the flow rate detected by the sensor 50 is within the normal flow rate range may be, for example, that leakage of the pressurized fluid occurs in the fluid supply path 12. Therefore, when the pressure detected by the sensor 30 is outside the normal pressure range while the flow rate detected by the sensor 50 is within the normal flow rate range, the determination unit 42 can determine that an abnormality has occurred in the supply of the pressurized fluid to the support unit 14. In such a case, the display control unit 44 displays a message indicating that an abnormality has occurred in the supply of the pressurized fluid to the support unit 14, on the display screen of the display unit 46.

There may be a case where the pressure detected by the sensor 30 is outside the normal pressure range and the flow rate detected by the sensor 50 is outside the normal flow rate range. In the case where the pressure detected by the sensor 30 is out of the normal pressure range and the flow rate detected by the sensor 50 is also out of the normal flow rate range, it is difficult to specify the failure location. Therefore, when the pressure detected by the sensor 30 is out of the normal pressure range and the flow rate detected by the sensor 50 is out of the normal flow rate range, the determination unit 42 can make a determination as follows. That is, in such a case, the determination unit 42 can determine that an abnormality has occurred in at least one of the supply of the pressurized fluid to the support unit 14 or the support unit 14. In such a case, the display control unit 44 displays, on the display screen of the display unit 46, a message indicating that an abnormality has occurred in the supply of the pressurized fluid to the support unit 14 or in the support unit 14.

When the determination unit 42 determines that the pressure detected by the sensor 30 is outside the normal pressure range, or when the determination unit 42 determines that the flow rate detected by the sensor 50 is outside the normal flow rate range, the control unit 40 can perform control to close the solenoid valve 32.

When the pressurized fluid from the fluid supply source 16 is normally supplied to the fluid supply path 12, the pressurized fluid flows through the fluid supply path 12 as shown in FIG. 5A.

When the pressure detected by the sensor 30 is out of the normal pressure range or when the flow rate detected by the sensor 50 is out of the normal flow rate range, the solenoid valve 32 is closed by the control unit 40. When the solenoid valve 32 is closed, as shown in FIG. 5B, the pressurized fluid stored in the tank 28 does not flow toward the fluid supply source 16. Therefore, according to the present embodiment, the pressurized fluid stored in the tank 28 can be sufficiently supplied to the support unit 14 via the pipe 13B.

As described above, according to the present embodiment, the sensor 30 and the sensor 50 are provided on the fluid supply path 12. Therefore, according to the present embodiment, it is possible to specify the failure location based on the detection result of the sensor 30 and the detection result of the sensor 50.

### Modified Examples

Although preferred embodiments of the present invention have been described above, the present invention is not limited to the above-described embodiments, and various modifications can be made thereto within a range that does not depart from the essence and gist of the present invention.

For example, in the above-described embodiments, the case where the tank 28 is provided with the two openings 29A and 29B has been described as an example, but the present invention is not limited thereto. The tank 28 may be provided with only one opening 29. In such a case, a branch pipe (not shown) branching from the pipe 13 may be connected to one opening 29 of the tank 28. Also in the case where the branch pipe branching from the pipe 13 is connected to the tank 28, it can be said that the tank 28 is provided on the fluid supply path 12. Even in the case where the branch pipe branching from the pipe 13 is connected to the tank 28, when the supply of the pressurized fluid from the fluid supply source 16 to the fluid supply path 12 is disrupted, the pressurized fluid stored in the tank 28 continues to be supplied to the support unit 14 for a relatively long time. Therefore, even in such a configuration, it is possible to sufficiently increase the length of time that elapses before the pressurized fluid excessively decreases in pressure.

In the above-described embodiments, the case where the support unit 14, the member 18, and the like are provided on the spindle 22 has been described as an example, but the present invention is not limited thereto. The support unit 14, that is, the static pressure bearing may be provided in a linear motion mechanism (not illustrated). The member 18 may be a shaft constituting part of such a linear motion mechanism. Such a linear motion mechanism can be provided in a balancer device, for example, but is not limited thereto. Such a balancer device serves for reducing the gravity acting on a slider (not shown), for example.

The above-described embodiments may be summarized in the following manner.

The pressurized fluid supply system (10) includes: the fluid supply path (12) configured to allow the pressurized fluid from the fluid supply source (16) to be supplied to the support unit (14) configured to support a member (18) using the pressurized fluid; and the tank (28) provided on the fluid supply path and configured to store the pressurized fluid. With this configuration, the length of time that elapses before the pressurized fluid excessively decreases in pressure can be made sufficiently long, and thus it is possible to stop rotating movement, sliding movement, or the like of the member before the pressurized fluid excessively decreases in pressure. Therefore, in this configuration, even if the supply of the pressurized fluid from the fluid supply source to the fluid supply path is disrupted, it is possible to prevent the member supported by using the pressurized fluid from being damaged.

The pressurized fluid supply system may further include: the sensor (30) provided on the fluid supply path and configured to detect a pressure of the pressurized fluid or the flow rate of the pressurized fluid; the solenoid valve (32) provided on the fluid supply path between the fluid supply source and the tank; and the control unit (40) configured to perform control to close the solenoid valve when the pressure or the flow rate detected by the sensor is out of the normal range. According to such a configuration, since the solenoid valve is closed when the supply of the pressurized fluid from the fluid supply source to the fluid supply path is disrupted, the pressurized fluid stored in the tank can be sufficiently supplied to the support unit. For this reason, with this configuration, it is possible to more reliably prevent a sudden pressure drop of the pressurized fluid used to support the member, and it is possible to more sufficiently lengthen the length of time that elapses before the pressurized fluid excessively decreases in pressure. The length of time that elapses before the pressurized fluid excessively decreases in pressure can be made more sufficiently long, and thus, according to this configuration, it is possible to more reliably stop rotating movement, sliding movement, or the like of the member before the pressurized fluid excessively decreases in pressure. Therefore, in this configuration, even if the supply of the pressurized fluid from the fluid supply source to the fluid supply path is disrupted, it is possible to more reliably prevent the member supported by using the pressurized fluid from being damaged.

The sensor may be the pressure sensor configured to detect the pressure, and the sensor may be provided on the fluid supply path between the fluid supply source and the solenoid valve. According to such a configuration, even when the solenoid valve is closed, the pressure sensor can detect whether or not the pressure of the pressurized fluid supplied from the fluid supply source has returned to normal.

The support unit may be a static pressure bearing that rotatably or slidably supports the member using the pressurized fluid.

1. A pressurized fluid supply system comprising:
a fluid supply path configured to allow a pressurized fluid from a fluid supply source to be supplied to a support unit configured to support a member using the pressurized fluid; and
a tank provided on the fluid supply path and configured to store the pressurized fluid.

2. The pressurized fluid supply system according to claim 1, further comprising:
a sensor provided on the fluid supply path and configured to detect a pressure of the pressurized fluid or a flow rate of the pressurized fluid;
a solenoid valve provided on the fluid supply path between the fluid supply source and the tank; and
a control unit configured to perform control to close the solenoid valve when the pressure or the flow rate detected by the sensor is out of a normal range.

3. The pressurized fluid supply system according to claim 2, wherein
the sensor is a pressure sensor configured to detect the pressure, and
the sensor is provided on the fluid supply path between the fluid supply source and the solenoid valve.

4. The pressurized fluid supply system according to any claim 1, wherein
the support unit is a static pressure bearing configured to rotatably or slidably support the member using the pressurized fluid.
